(19) United States
(12) Patent Application Publication
(10) Pub. No.: US 2026/0343677 A1
(43) Pub. Date: Oct. 29, 2026

(54) MULTICAST FOR A VIRTUAL NETWORK

(71) Applicant: Lenovo (Beijing) Limited, Beijing (CN)

(72) Inventors: Haiyan Luo, Shanghai (CN); Tingfang Tang, Beijing (CN); Genadi Velev, Darmstadt (DE); Mingzeng Dai, Shanghai (CN)

(73) Assignee: Lenovo (Beijing) Limited, Beijing (CN)

(21) Appl. No.: 19/106,415

(22) PCT Filed: Aug. 31, 2022
(86) PCT No.: PCT/CN2022/116034

§ 371 Date: Feb. 25, 2025

(51) Int. Cl. H04W 76/40; H04L 12/18; H04W 76/11; H04W 76/12

(52) U.S. Cl. CPC H04W 76/40; H04L 12/189; H04W 76/11; H04W 76/12

(57) ABSTRACT

Method and apparatus for multicast scheme improvement for 5G Virtual Network are disclosed. In one embodiment, session management function (SMF) comprises a processor and a transceiver coupled to the processor, wherein the processor is con-2024/045002 figured to transmit, via the transceiver, to a RAN node, UE group ID identifying a group of UEs; and receive, via the transceiver, from the RAN node, RAN tunnel info for the group of UEs, where the RAN tunnel info for the group of UEs is associated with a shared tunnel to be established for the group of UEs between the RAN node and UPF.

### FIELD

The subject matter disclosed herein generally relates to wireless communications, and more particularly relates to multicast scheme improvement for 5G Virtual Network.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Virtual Network (VN), Data Network (DN), User Plane Function (UPF), Multicast and Broadcast Service (MBS), Radio Access Network (RAN), Technical Specification (TS), Multicast/Broadcast Service Function (MBSF), Multicast/Broadcast Service Transport Function (MBSTF), network function (NF), Point-to-MultiPoint (PTM), Packet Detection Rule (PDR), Forwarding Action Rule (FAR), Session Management Function (SMF), Session Management (SM), Unified Data Management (UDM), Access and Mobility Management Function (AMF), Protocol Data Unit (PDU), Operations Administration and Maintenance (OAM), Core Network (CN), Next Generation User plane interface (NG-U), Transport Network Layer (TNL), User Plane Function (UPF), Quality of Service (QOS), QoS Enforcement Rule (QER), Usage Reporting Rule (URR), QOS Flow Identifier (QFI), NG Application Protocol (NGAP), Policy Control Function (PCF), Internet Group Management Protocol (IGMP), Multicast Listener Discovery (MLD), Policy and Charging Control (PCC), Public Land Mobile Network (PLMN), Radio Network Temporary Identifier (RNTI), Group RNTI (G-RNTI), Group Configured Scheduling RNTI (G-CS-RNTI), Temporary Mobile Group Identity (TMGI), MBS Radio Bearer (MRB), Downlink Control Information (DCI), Cell Radio Network Temporary Identifier (C-RNTI), Media Access Control (MAC), Control Element (CE), Non Access Stratum (NAS), Internet Protocol (IP), Core network (CN).

In 3GPP Release 16, 5G Virtual Network (VN) group was introduced for a set of UEs using private communication for 5G LAN-type service. One to one communication supports forwarding of unicast traffic between two UEs within a 5G VN, or between a UE and a device on the DN. One-to-many communication supports forwarding of multicast traffic or broadcast traffic from one UE (or device on the DN) to many or all UEs within a 5G VN and devices on the DN.

There are mainly three types of one-to-many communication, i.e., from N6 interface (between DN and UPF), from N19 interface (between UPF and UPF) and from N3 interface (between RAN node and UPF).

As shown in FIG. 1(a), if UPF (e.g., UPF #1) receives a broadcast packet from N6 or N19 interface (from DN or UPF #2), UPF #1 performs traffic replication and distribution to all UEs (e.g., N UEs) of the 5G VN group connected to UPF #1. In particular, UPF #1 replicates N copies of the broadcast packet and distributes each of the N copies over individual tunnel (which means a tunnel between UPF #1 and RAN node for each of the N UEs) over N3 interface for specific PDU session to each of N UEs. It implies that the 5G VN group contains N UEs connected to UPF #1.

As shown in FIG. 1(b), if UPF (e.g., UPF #1) receives a broadcast packet from a source UE (connected to a RAN node) via PDU session associated with a 5G VN group, UPF #1 performs traffic replication and distribution over N3, N6 and N19 interfaces. In particular, UPF #1 shall distribute the packet to all UEs of the 5G VN group (except the source UE) connected to UPF #1 via local switch, to all UEs of the 5G VN group connected to other UPFs (e.g., UPF #2) via N19-based forwarding, and to the devices on the DN via N6-based forwarding.

It can be seen that, UPF #1 replicates a copy of the broadcast packet for each of the N UEs connected to UPF #1. It wastes resources.

This invention targets multicast scheme improvement for 5G Virtual Network.

### BRIEF SUMMARY

Method and apparatus for multicast scheme improvement for 5G Virtual Network are disclosed.

In one embodiment, SMF comprises a processor and a transceiver coupled to the processor, wherein the processor is configured to transmit, via the transceiver, to a RAN node, UE group ID identifying a group of UEs; and receive, via the transceiver, from the RAN node, RAN tunnel info for the group of UEs, where the RAN tunnel info for the group of UEs is associated with a shared tunnel to be established for the group of UEs between the RAN node and UPF.

In some embodiment, the processor is further configured to transmit, via the transceiver, to the RAN node, an indication of shared tunnel.

In some embodiment, the processor is further configured to transmit, via the transceiver, to the RAN node, CN tunnel info for the PDU session identified by the PDU session ID; and receive, via the transceiver, from the RAN node, RAN tunnel info for the PDU session, where, the RAN tunnel info for the PDU session is associated with a tunnel to be established for the PDU session between the RAN node and the UPF.

In some embodiment, the processor is further configured to transmit, via the transceiver, to the RAN node, UE ID and PDU session ID for each UE in the group of UEs.

In some embodiment, the processor is further configured to transmit, via the transceiver, to the RAN node, IP multicast addressing information and IP broadcast addressing information.

In some embodiment, the processor is further configured to receive, via the transceiver, from the RAN node, RAN tunnel info for each multicast group consisting of a part of the group of UEs, where, the RAN tunnel info for each multicast group is associated with a shared tunnel to be established for the multicast group between the RAN node and the UPF.

In some embodiment, the processor is further configured to transmit, via the transceiver, to UPF, PDR and FAR associated with the group of UEs and/or a part of the group of UEs.

In another embodiment, a method at SMF comprises transmitting, to a RAN node, UE group ID identifying a group of UEs; and receiving, from the RAN node, RAN tunnel info for the group of UEs, where, the RAN tunnel info for the group of UEs is associated with a shared tunnel to be established for the group of UEs between the RAN node and UPF.

In yet another embodiment, a network node (e.g., RAN node) of a network architecture comprises: a processor and a transceiver coupled to the processor, wherein the processor is configured to receive, via the transceiver, from SMF, UE group ID identifying a group of UEs; and transmit, via the transceiver, to SMF, RAN tunnel info for the group of UEs, where, the RAN tunnel info for the group of UEs is associated with a shared tunnel to be established for the group of UEs between the RAN node and UPF.

In some embodiment, the processor is further configured to receive, via the transceiver, from the SMF, an indication of shared tunnel.

In some embodiment, the processor is further configured to receive, via the transceiver, from the SMF, CN tunnel info for the PDU session identified by the PDU session ID; and transmit, via the transceiver, to the SMF, RAN tunnel info for the PDU session, where, the RAN tunnel info for the PDU session is associated with a tunnel to be established for the PDU session between the RAN node and the UPF.

In some embodiment, the processor is further configured to receive, via the transceiver, from the SMF, UE ID and PDU session ID for each UE in the group of UEs.

In some embodiment, the processor is further configured to receive, via the transceiver, from the SMF, IP multicast addressing information and IP broadcast addressing information.

In some embodiment, the processor is further configured to transmit, via the transceiver, to the SMF, RAN tunnel info for each multicast group consisting of a part of the group of UEs, where, the RAN tunnel info for each multicast group is associated with a shared tunnel to be established for the multicast group between the RAN node and the UPF.

In some embodiment, the processor is further configured to determine to trigger shared tunnel establishment between UPF and RAN node.

In some embodiment, the processor is further configured to send, via the transceiver, to all UEs or a part of UEs of the group of UEs, mapping relationship between PDU session ID and MRB ID(s), G-RNTI or G-CS-RNTI associated with the group of UEs.

In further embodiment, a method at RAN node comprises receiving, from SMF, UE group ID identifying a group of UEs; and transmitting, to SMF, RAN tunnel info for the group of UEs, where, the RAN tunnel info for the group of UEs is associated with a shared tunnel to be established for the group of UEs between the RAN node and UPF.

### BRIEF DESCRIPTION OF THE DRAWINGS

A more particular description of the embodiments briefly described above will be rendered by referring to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1(a) illustrates an example of one-to-many communication for VN group;

FIG. 1(b) illustrates another example of one-to-many communication for VN group;

FIG. 2 illustrates an improved broadcast or multicast mechanism for 5G VN group;

FIG. 3 illustrates a first sub-embodiment of the first embodiment;

FIG. 4 illustrates a second sub-embodiment of the first embodiment;

FIG. 5 illustrates a third sub-embodiment of the first embodiment;

FIG. 6 illustrates a first sub-embodiment of the second embodiment;

FIG. 7 illustrates a second sub-embodiment of the second embodiment;

FIG. 8 illustrates a third sub-embodiment of the second embodiment;

FIG. 9 illustrates a first sub-embodiment of the third embodiment;

FIG. 10 illustrates a second sub-embodiment of the third embodiment;

FIG. 11 illustrates a third sub-embodiment of the third embodiment;

FIG. 12 is a schematic flow chart diagram illustrating an embodiment of a method;

FIG. 13 is a schematic flow chart diagram illustrating a further embodiment of a method; and

FIG. 14 is a schematic block diagram illustrating another apparatus according to one embodiment.

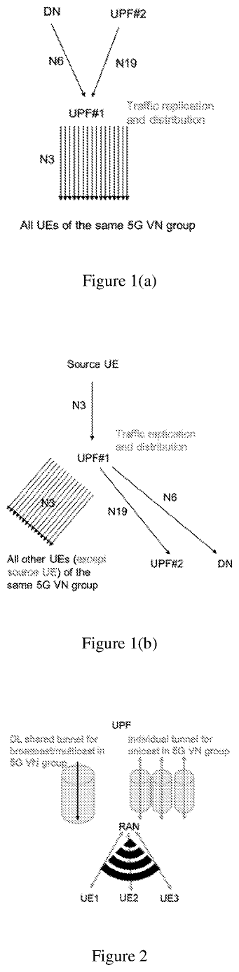

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

As described in the background part, UPF wastes resources when it replicates a copy of the broadcast packet for each of the N UEs from the same 5G VN group connected to itself.

In 3GPP Release 17, Multicast and Broadcast Service (MBS) is introduced as a point-to-multipoint service in which data is transmitted from a single source entity to multiple recipients, either to all users in a broadcast service area, or to some users in a multicast group. MBS works in a more efficient way than one-to-many transmission introduced in 5G VN group. Specifically, MBS introduces a shared tunnel between MBS-UPF and RAN node, which sends only one copy of the broadcast or multicast packets from MBS-UPF to RAN node. Besides, MBS introduces the broadcast or multicast transmission over air interface. That is, RAN node sends only one copy of the broadcast or multicast packets. However, MBS introduces multiple new NFs (e.g., MBS-SMF, MBS-UPF, MBSF, MBSTF, etc.) and new procedures (e.g., MBS session creation, UE session join etc.). In addition, MBS only supports broadcast or multicast traffic from DN.

In this disclosure, the main idea is to introduce a shared tunnel between UPF and RAN node for specific 5G VN group and utilize the MBS scheme over air interface without introducing or reusing the new NFs for MBS architecture. FIG. 2 illustrates an improved broadcast or multicast mechanism for 5G VN group according to this disclosure. As can be seen from FIG. 2, at least one DL shared tunnel for transmission of broadcast traffic and/or multicast traffic of a 5G VN group is introduced in addition to individual tunnels each of which is between UPF and RAN node for the PDU session of each UE for unicast transmission within the 5G VN group. Alternative to one DL shared tunnel for transmission of broadcast traffic and/or multicast traffic, there can be one DL shared broadcast tunnel for transmission of broadcast traffic and DL shared multicast tunnels each of which is for transmission of multicast traffic associated with a specific multicast group, where the UEs of the specific multicast group are a part of the UEs (i.e., some UEs) of the 5G VN group. Upon receiving the broadcast or multicast packets over a DL shared tunnel (or DL shared broadcast tunnel or DL shared multicast tunnel), RAN node shall perform MBS transmission (e.g., Point-to-MultiPoint, PTM) for broadcast or multicast packets towards all or some UEs of the 5G VN group. Incidentally, one UPF may be connected to multiple RAN nodes. The DL shared tunnel (or DL shared broadcast tunnel and DL shared multicast tunnel(s)) for each 5G VN group shall be established between the UPF and each RAN node to which UEs of the 5G VN group are connected.

The following embodiments target the following issues:
Issue 1: How to trigger the establishment of the shared tunnel between UPF and RAN node for a specific 5G VN group?
Issue 2: How to configure the corresponding PDR (Packet Detection Rule) and FAR (Forwarding Action Rule) associated with the shared tunnel for the 5G VN group?
Issue 3: How could RAN node identify multicast traffic of specific multicast group and forward to the corresponding UEs within the 5G VN group?
Issue 4: Upon receiving broadcast or multicast packets over air interface, how could UE know which PDU session it is associated with? Or how could UE know which application the packets belong to?

In this disclosure, broadcast traffic means the traffic for all the UEs within the 5G VN group (or specifically all the UEs within the 5G VN group connected to a RAN node); while multicast traffic means the traffic for some UEs (within the 5G VN group connected to the RAN node) joining a multicast group. There can be multiple multicast groups. Each multicast group is associated with different multicast traffic. It means that specific multicast traffic is for the UEs joining a specific multicast group.

A shared channel between UPF and RAN node can be used for broadcast traffic within the 5G VN group or any specific multicast traffic for specific multicast group.

Three scenarios are considered.

In a first scenario, only broadcast traffic is supported, while multicast traffic is not supported. A shared tunnel (e.g., DL shared broadcast tunnel) is used for broadcast traffic within the 5G VN group.

In a second scenario, both broadcast traffic and multicast traffic are supported. In addition, it is assumed that broadcast traffic and multicast traffic share the same shared tunnel between UPF and RAN node. For example, one shared tunnel (e.g., DL shared tunnel) is used for transmission of both broadcast traffic for the 5G VN group and multicast traffic for each multicast group within the 5G VN group.

In a third scenario, both broadcast traffic and multicast traffic are supported. However, it is assumed that broadcast traffic and multicast traffic do not share the same shared tunnel between UPF and RAN node. For example, one shared broadcast tunnel (e.g., DL shared broadcast tunnel) is used for transmission of broadcast traffic within the 5G VN group, and each of multiple shared multicast tunnels (e.g., DL shared multicast tunnels) is used for transmission of specific multicast traffic associated with a specific multicast group.

A first embodiment relates to control plane handling for the first scenario, i.e., establishment of the shared tunnel for 5G VN group (i.e., for broadcast traffic).

According to a first sub-embodiment of the first embodiment, the shared tunnel for 5G VN group is established per UE per session signaling, and is triggered by SMF. The shared tunnel for 5G VN group will be established together with the individual tunnel for PDU session of the UE.

Upon PDU session establishment, SMF retrieves Session Management (SM) Subscription data from UDM. If the UE belongs to 5G VN group, the SM Subscription data contains Internal Group ID (for 5G VN group) and secondary authentication indicator. In the first sub-embodiment of the first embodiment, it is assumed that SMF provides 5G VN group ID (e.g., internal group ID) to RAN node upon PDU session establishment procedure. For example, SMF provides AMF with the N2 SM information with 5G VN group ID in step 11 of PDU session establishment procedure in 3GPP TS 23.502 4.3.2.2.1, and the N2 SM information will be forwarded from SMF to RAN node by AMF. RAN node shall add UE ID and PDU session ID into 5G VN group.

According to the first sub-embodiment of the first embodiment, SMF triggers shared tunnel establishment. It means that SMF decides to configure the shared tunnel for 5G VN group. For example, if SMF finds that there are more than N (N can be a predetermined integer) UEs within one RAN node joining the same 5G VN group, it decides to trigger the one RAN node to configure the shared tunnel for the 5G VN group. Alternatively, SMF may determine to trigger the shared tunnel for the 5G VN group based on other reasons, e.g., the heavy load of UPF. SMF may obtain the MBS capability of each RAN node in advance, e.g., by OAM configuration or RAN report, and decide to configure, with which RAN node(s) the shared tunnel for the 5G VN group is established.

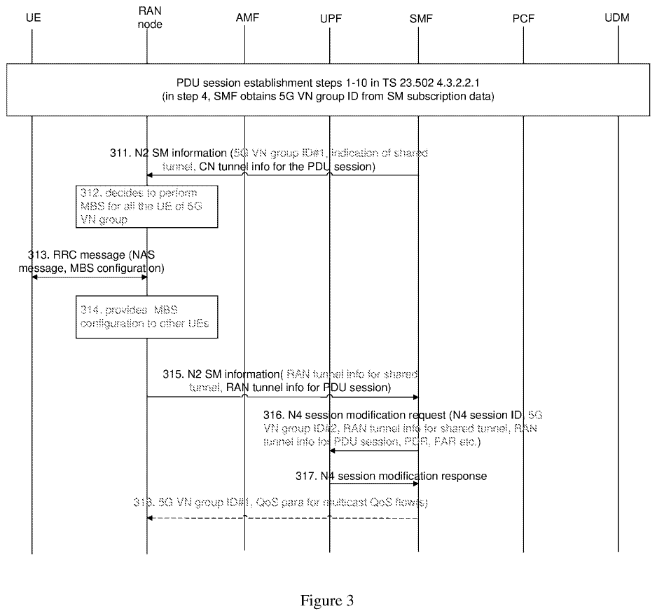

FIG. 3 illustrates the first sub-embodiment of the first embodiment.

Steps 1-10 of PDU session establishment procedure in 3GPP TS 23.502 4.3.2.2.1 are executed. In particular, in step 4, SMF obtains SM subscription data from UDM, which contains 5G VN group ID (i.e., internal group ID). SMF determines to trigger the establishment of the shared tunnel for the 5G VN group between RAN node and UPF.

In step 311, SMF provides RAN node with, in addition to PDU session ID indicating an PDU session, the N2 SM information associated with the PDU session including 5G VN group ID #1, indication of shared tunnel, CN tunnel info (where ‘info’ is an abbreviation of ‘information’) for the PDU session, where 5G VN group ID #1 is 5G VN group ID to identify the 5G VN group between SMF and RAN node, and 5G VN group ID #1 may be internal group ID in SM subscription data or other ID assigned by SMF for the 5G VN group ID. The CN tunnel info for the PDU session corresponds to the Core Network address(es) of the N3 tunnel corresponding to the PDU session, which is the UL NG-U TNL information at UPF side. For example, step 311 can be implemented as: SMF provides AMF with the PDU session ID, N2 SM information and NAS message (e.g., PDU session establishment accept) in Namf_Communication_N1N2MessageTransfer; then AMF forwards the PDU session ID, N2 SM information and NAS message to the corresponding RAN node in N2 PDU Session Request message.

Steps 312 and 314 are performed by assuming that RAN node supports MBS.

In step 312, upon receiving the 5G VN group ID and indication of shared tunnel, RAN node decides to perform MBS over air interface for broadcast traffic within the 5G VN group identified by the 5G VN group ID.

In step 313, RAN node sends RRC message to UE, which includes the NAS message and MBS configuration.

In step 314, RAN node provides MBS configuration to other UE(s) of the same 5G VN group. It is assumed that SMF provides RAN node with the 5G VN group ID upon each PDU session establishment procedure associated with the RAN node. RAN node shall add UE ID and PDU session ID into the 5G VN group. Therefore, RAN node shall inform all the members (e.g., UEs) of 5G VN group of the MBS configuration in order for them to receive the broadcast packets.

In step 315, RAN node provides SMF with the N2 SM information associated with the PDU session. The N2 SM information includes: 5G VN group ID #1 (optional), RAN tunnel info for shared tunnel (i.e., for 5G VN group), and RAN tunnel info for PDU session. 5G VN group ID #1 is optional in the condition that one PDU session is associated with one 5G VN group. That is, RAN node provides RAN tunnel info for 5G VN group and RAN tunnel info for PDU session together in one piece of N2 SM information. The RAN tunnel info for the group of UEs is associated with a shared tunnel to be established for the group of UEs between RAN node and UPF. The RAN tunnel info for the PDU session is associated with a tunnel to be established for the PDU session between RAN node and UPF. As an example, the RAN tunnel info refers to DL NG-U TNL information at RAN side. Step 315 can be implemented as: RAN node provides AMF with the PDU session ID and N2 SM information in N2 PDU session response message, then AMF forwards the PDU session ID and N2 SM information to the corresponding SMF in Nsmf_PDUSession_UpdateSMContext Request. Alternatively, RAN node may provide the RAN tunnel info for 5G VN group and optionally the PDU session ID or 5G VN group ID #1 in a separate message towards SMF.

Incidentally, if the RAN node does not support MBS, upon receiving the 5G VN group ID #1 and the indication of shared tunnel in step 311, the RAN node will not perform steps 312 and 314. Besides, there's no MBS configuration in step 313. In step 315, SMF infers from the absence of an “MBS-support” indication in N2 SM response from RAN node that the RAN node does not support MBS, and accordingly, steps 316-318 are not performed. Alternatively, RAN node can provide SMF with an indication of supporting MBS with value ‘false’ or ‘0’ (i.e., not supporting MBS).

Step 315 may be performed before step 313.

In addition, steps 315-317 may be performed before steps 313-314.

In step 316, SMF sends UPF the N4 session modification request message, which includes N4 session ID, 5G VN group ID #2, RAN tunnel info for shared tunnel (i.e., for 5G VN group), RAN tunnel info for PDU session, and packet detection, enforcement and reporting rules to be installed on the UPF for the PDU Session (e.g., PDR, FAR, QER etc. associated with 5G VN group ID #2), etc. 5G VN group ID #2 is network interface, internal group ID or other ID assigned by SMF for the 5G VN group (i.e., 5G VN group ID #2 is used to identify the 5G VN group between SMF and UPF). SMF has the relationship between 5G VN group ID #1 and 5G VN group ID #2. Alternatively, SMF may provide UPF in a separate message with 5G VN group ID #2, RAN tunnel info for shared tunnel (i.e., for 5G VN group), and corresponding PDR and FAR, etc. Incidentally, the PDR and the FAR will be discussed in detail in the fourth embodiment that will be discussed later.

In step 317, UPF sends N4 session modification response message to SMF.

In an optional step 318, SMF provides RAN node with 5G VN group ID #1, MBS QoS Flow Identifier (QFI) and MBS QoS Flow Level QoS Parameters. For example, SMF may construct the QoS parameters for MBS QoS flows by considering all the members (e.g., UEs) of the 5G VN group. Assuming that there are 20 UEs in one 5G VN group, and each UE has 2 QoS flows (e.g., QoS flow #1 and QoS flow #2). SMF constructs QoS parameters for MBS QoS flow #1 by considering all 20 UE's QoS flow #1 with similar QoS requirements. SMF constructs QoS parameters for MBS QoS flow #2 by considering all 20 UE's QoS flow #2 with similar QoS requirements. Alternatively, SMF may provide MBS QOS Flow Identifier and MBS QoS Flow Level QoS Parameters in step 311. MBS QoS flow level QoS parameters include 5QI, packet error rate, packet delay budget, Maximum Data Burst Volume, etc.

If extra UE(s) join the 5G VN group later, SMF may update the MBS QoS flow level QoS parameters for MBS QoS flow by considering extra UE(s)' QoS parameter(s). That is, SMF may trigger PDU session modification procedure to provide the updated MBS QoS flow level QoS parameters for the 5G VN group, or SMF may trigger a new procedure to provide the updated MBS QoS flow level QoS parameters for 5G VN group.

According to a second sub-embodiment of the first embodiment, the shared tunnel for 5G VN group is established per UE per session signaling, and is triggered by RAN node. Similar to the first sub-embodiment, the shared tunnel for 5G VN group will be established together with the individual tunnel for PDU session of the UE.

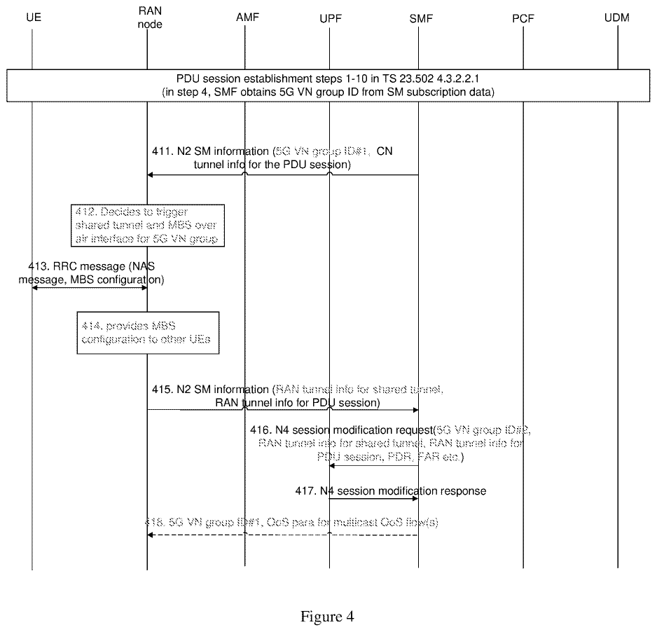

FIG. 4 illustrates the second sub-embodiment of the first embodiment.

Steps 1-10 of PDU session establishment procedure in 3GPP TS 23.502 4.3.2.2.1 are executed. For example, in step 4, SMF obtains SM subscription data from UDM, which contains 5G VN group ID (i.e., internal group ID).

In step 411, SMF provides RAN node with, in addition to PDU session ID indicating a PDU session, the N2 SM information associated with PDU session including 5G VN group ID #1, CN tunnel info for PDU session. Step 411 differs from step 311 in that the indication of shared tunnel is not provided in the N2 SM information.

In step 412, RAN node determines to trigger shared tunnel for the 5G VN group (identified by 5G VN group ID #1) between RAN node and UPF, and perform MBS over air interface for broadcast traffic within the 5G VN group. For example, if RAN node finds that there are more than N (N can be a predetermined integer) UEs joining the 5G VN group, RAN node determines to establish shared tunnel and perform MBS over air interface for the 5G VN group. Alternatively, RAN node may decide to trigger the shared tunnel for 5G VN group based on other reasons, e.g., the heavy load of itself.

Steps 413-417 and optional step 418 are the same as steps 313-318.

According to a third sub-embodiment of the first embodiment, the shared tunnel for 5G VN group is established per node signaling, and is triggered by SMF.

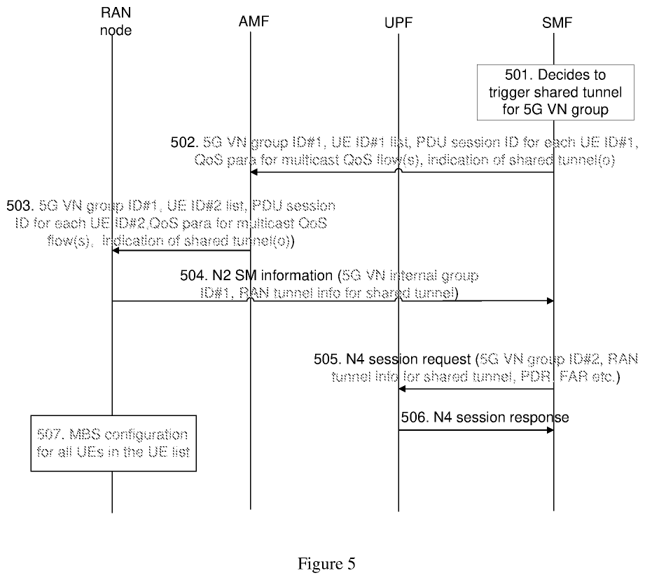

FIG. 5 illustrates the third sub-embodiment of the first embodiment.

In step 501, SMF determines to trigger shared tunnel between UPF and RAN node for the 5G VN group. The reasons to determine to trigger shared tunnel for the 5G VN group may be the same as those described in the first sub-embodiment of the first embodiment.

In step 502, SMF provides AMF with the 5G VN group ID #1 (where 5G VN group ID #1 is 5G VN group ID to identify the 5G VN group between SMF and RAN node, and may be internal group ID in SM subscription data or other ID assigned by SMF), UE ID #1 list (including all UE ID #1s of all UEs of the 5G VN group accessing to the same RAN node, where a UE ID #1 is a UE ID (e.g., SUPI) used between SMF and AMF to identify a UE), PDU session ID for each UE ID #1, QoS para for multicast QoS flows (e.g., MBS QoS Flow Identifier and MBS QoS Flow Level QoS Parameters). Upon receiving the 5G VN group ID and other parameters (e.g., in step 503 that will be discussed later), RAN node shall configure shared tunnel for the 5G VN group. Optionally, SMF may also provide indication of shared tunnel to explicitly inform RAN node to configure the shared tunnel. For the step 502, a new per node message shall be introduced between SMF and AMF or an existing per node message can be reused.

AMF translates each UE ID #1 into a UE ID #2 used between AMF and RAN node (e.g., AMF UE NGAP ID and/or RAN UE NGAP ID) to identify a UE. In step 503, AMF provides RAN node with the 5G VN group ID #1, UE ID #2 list, PDU session ID for each UE ID #2, QoS para for multicast QoS flows (e.g., MBS QoS Flow Identifier and MBS QoS Flow Level QoS parameters), and optionally the indication of shared tunnel.

In step 504, RAN node provides SMF with the N2 SM information (5G VN group ID #1, RAN tunnel info for the shared tunnel). In particular, RAN node provides AMF with the N2 SM information in a new per node N2 message or by reusing an existing N2 message. Then AMF forwards the N2 SM information to the corresponding SMF in a new per node N2 Request or by reusing an existing message.

In step 505, SMF sends UPF the N4 session request message, which includes 5G VN group ID #2, RAN tunnel info for shared tunnel and corresponding PDR and FAR etc.

In step 506, UPF sends N4 session response message to SMF.

In step 507, RAN node sends, to all the UEs of the 5G VN group, RRC message which includes the MBS configuration. Step 507 can be performed before steps 505 and 506.

The above description of the third sub-embodiment of the first embodiment assumes that RAN node supports MBS. If RAN node does not support MBS, RAN node, in step 504, provides the indication of not supporting MBS (i.e., the value is ‘false’ or ‘0’) without RAN tunnel info for 5G VN group. In addition, steps 505-507 are not performed.

A second embodiment relates to control plane handling for the second scenario, i.e., shared tunnel establishment for both 5G VN group (i.e., broadcast traffic) and multicast groups (i.e., multicast traffic).

According to a first sub-embodiment of the second embodiment, the shared tunnel for both 5G VN group and each of multicast groups is established per UE per session signaling, and is triggered by SMF. The shared tunnel will be established together with the individual tunnel for PDU session of the UE.

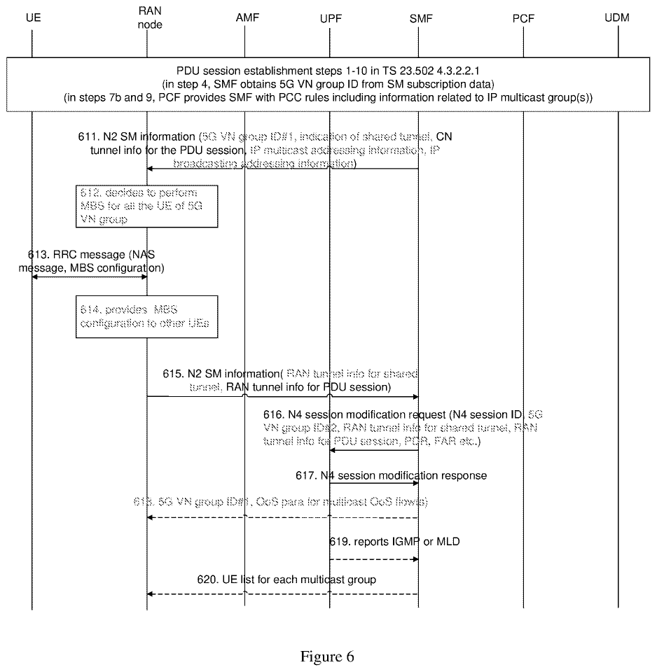

FIG. 6 illustrates the first sub-embodiment of the second embodiment, in which SMF triggers shared tunnel establishment per UE per session signaling. The steps in FIG. 6 are similar to the steps in FIG. 3. In view of the above, only the differences are described in detail.

In steps 7b and 9 of PDU session establishment procedure in 3GPP TS 23.502 4.3.2.2.1, PCF provides SMF with PCC Rules including information related to IP multicast group(s), e.g., the IP multicast addressing information.

In step 611, the N2 SM information includes, in addition to 5G VN group ID #1, indication of shared tunnel and CN tunnel info for PDU session (as described in step 311), IP multicast addressing information (which is for multicast) and IP broadcast addressing information (which is for broadcast).

Based on the IP multicast addressing information, RAN node knows all the UE IDs and PDU session IDs associated with a specific IP multicast group. Based on IP multicast addressing information and IP broadcast addressing information, RAN node is able to identify the broadcast packets and multicast packets related with the specific IP multicast group.

Steps 612 to 618 can be the same as steps 312 to 318. Additionally, SMF may provide UPF with the PDR, FAR and URR associated with IGMP or MLD in step 616 or a separate N4 signaling. E.g., PDR is used to identify IGMP signaling or MLD together with IP Multicast Addressing information identifying a set of IP multicast groups. FAR includes an “IP Multicast Accept” action or an “IP Multicast Deny” action in order to request UPF to accept or deny UE requests to join the corresponding IP multicast group(s). URR has a Reporting Trigger set to “IGMP reporting” for IGMP or set to “MLD reporting” for MLD.

In optional step 619, SMF may receive IGMP or MLD reporting (e.g., whether UE is allowed to join a specific IP multicast group) from UPF if UPF is configured to report IGMP or MLD.

In optional step 620, SMF may update the UE list for each IP multicast group to RAN node if the UE list has changed (e.g., a new UE has joined a specific IP multicast group). RAN node will adjust the UE list for each IP multicast group accordingly.

According to a second sub-embodiment of the second embodiment, the shared tunnel for both 5G VN group and each of multicast groups is established per UE per session signaling, and is triggered by RAN node. The shared tunnel will be established together with the individual tunnel for PDU session of the UE.

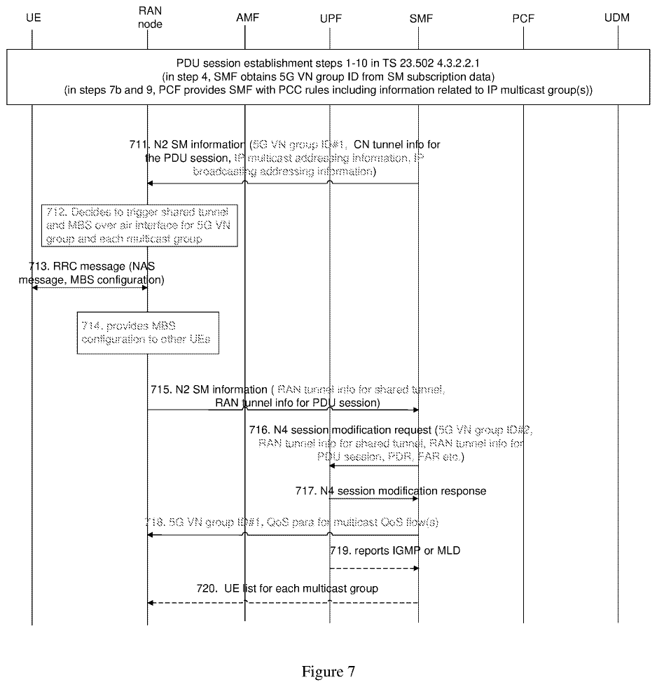

FIG. 7 illustrates the second sub-embodiment of the second embodiment, in which RAN node triggers shared tunnel establishment per UE per session signaling. The steps in FIG. 7 are similar to the steps in FIG. 4. In view of the above, only the differences are described in detail.

In steps 7b and 9 of PDU session establishment procedure in 3GPP TS 23.502 4.3.2.2.1, PCF provides SMF with PCC Rules including information related to IP multicast group(s), e.g., the IP multicast addressing information.

In step 711, the N2 SM information includes, in addition to 5G VN group ID #1 and CN tunnel info for PDU session (as described in step 411), IP multicast addressing information (which is for multicast) and IP broadcast addressing information (which is for broadcast).

Based on the IP multicast addressing information, RAN node knows all the UE IDs and PDU session IDs associated with a specific IP multicast group. Based on IP multicast addressing information and IP broadcast addressing information, RAN node is able to identify the broadcast packets and multicast packets related with the specific IP multicast group.

In step 712, RAN node determines to trigger shared tunnel between RAN node and UPF, in addition to for the 5G VN group (identified by 5G VN group ID #1), for each multicast group within the 5G VN group. It means that the shared tunnel is established between RAN node and UPF for both 5G VN group and each of multicast groups. In addition, RAN node determines to perform MBS over air interface for both broadcast traffic and multicast traffic within the 5G VN group.

Steps 713 to 718 can be the same as steps 413 to 418. Additionally, SMF may provide UPF with the PDR, FAR and URR associated with IGMP or MLD in step 716 or a separate N4 signaling.

In optional step 719, SMF may receive IGMP or MLD reporting (e.g., whether UE is allowed to join a specific IP multicast group) from UPF if UPF is configured to report IGMP or MLD. Additionally, SMF may provide UPF with the PDR, FAR and URR associated with IGMP or MLD in step 716 or a separate N4 signaling.

In optional step 720, SMF may update the UE list for each IP multicast group to RAN node if the UE list has changed (e.g., a new UE has joined a specific IP multicast group). RAN node will adjust the UE list for each IP multicast group accordingly.

According to a third sub-embodiment of the second embodiment, the shared tunnel for both 5G VN group and each of multicast groups is established per node signaling, and is triggered by SMF.

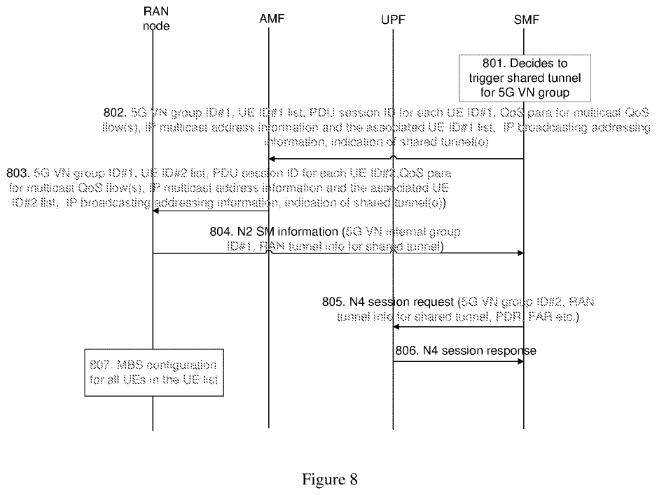

FIG. 8 illustrates the third sub-embodiment of the second embodiment. The steps in FIG. 8 are similar to the steps in FIG. 5. In view of the above, only the differences are described in detail.

Steps 801 and 804-807 are the same as steps 501 and 504-507, respectively. In step 802, SMF provides AMF with, in addition to 5G VN group ID #1, UE ID #1 list, PDU session ID for each UE ID #1, QoS para for multicast QoS flows and optionally indication of shared tunnel, IP multicast addressing information (which is for multicast) and the associated UE ID #1 list and IP broadcast addressing information (which is for broadcast). It means that IP multicast addressing information and the associated UE ID #1 list, and IP broadcast addressing information are further provided from SMF to RAN node in the third sub-embodiment of the second embodiment.

In step 803, after translating UE ID #1 into UE ID #2 which can be identified by RAN node, AMF provides RAN node with, in addition to 5G VN group ID #1, UE ID #2 list, PDU session ID for each UE ID #2, QoS para for multicast QoS flows and optionally the indication of shared tunnel, IP multicast addressing information (which is for multicast) and the associated UE ID #2 list and IP broadcast addressing information (which is for broadcast).

The associated UE ID list (i.e., the associated UE ID #1 list in step 802, and the associated UE ID #2 list in step 803) is provided to identify which UEs are associated with the IP multicast addressing information.

A third embodiment relates to control plane handling for the third scenario, i.e., establishment of one shared broadcast tunnel for 5G VN group (i.e., broadcast traffic) and shared multicast tunnels each of which is for a specific multicast group (i.e., multicast traffic).

According to a first sub-embodiment of the third embodiment, the shared broadcast tunnel for 5G VN group and the shared multicast tunnels for multicast groups are established per UE per session signaling, and are triggered by SMF. The shared broadcast tunnel and the shared multicast tunnels will be established together with the individual tunnel for PDU session of the UE.

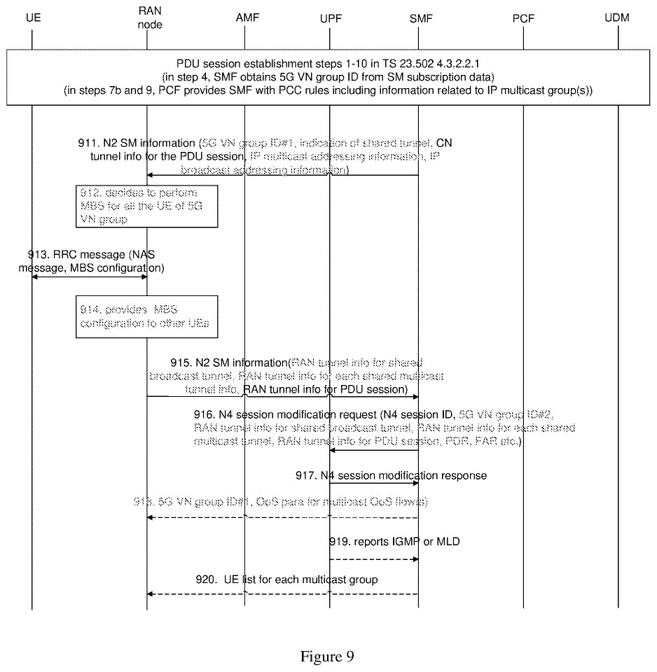

FIG. 9 illustrates the first sub-embodiment of the third embodiment. The steps in FIG. 9 are similar to the steps in FIG. 6. Only steps 915 and 916 are different from steps 615 and 616. Other steps 911-914 and 917-920 are the same as steps 611-614 and 617-620. It is assumed that, as long as SMF provides the IP multicast addressing information and IP broadcast addressing information together, along with an indication of shared tunnel (optional), it triggers separate shared tunnels for broadcast traffic and multicast traffic respectively. Alternatively, SMF may provide RAN node with the indication of separate shared tunnel to explicitly trigger separate shared tunnels.

In step 615, RAN node provides SMF with the N2 SM information associated with the PDU session including RAN tunnel info for shared tunnel (i.e., for 5G VN group) and RAN tunnel info for PDU session. In step 915, the RAN tunnel info for shared tunnel is renamed as RAN tunnel info for shared broadcast tunnel, and the N2 SM information further includes RAN tunnel info for each shared multicast tunnel. The RAN tunnel info for each shared multicast tunnel is associated with a shared tunnel to be established for the multicast group between the RAN node and the UPF.

Similar to step 915, in step 916, the N4 session modification request message includes RAN tunnel info for shared broadcast tunnel (renamed from “RAN tunnel info for shared tunnel”) and further includes RAN tunnel info for each shared multicast tunnel.

According to a second sub-embodiment of the third embodiment, the shared broadcast tunnel for 5G VN group and the shared multicast tunnels for multicast groups are established per UE per session signaling, and are triggered by RAN node. The shared broadcast tunnel and the shared multicast tunnels will be established together with the individual tunnel for PDU session of the UE.

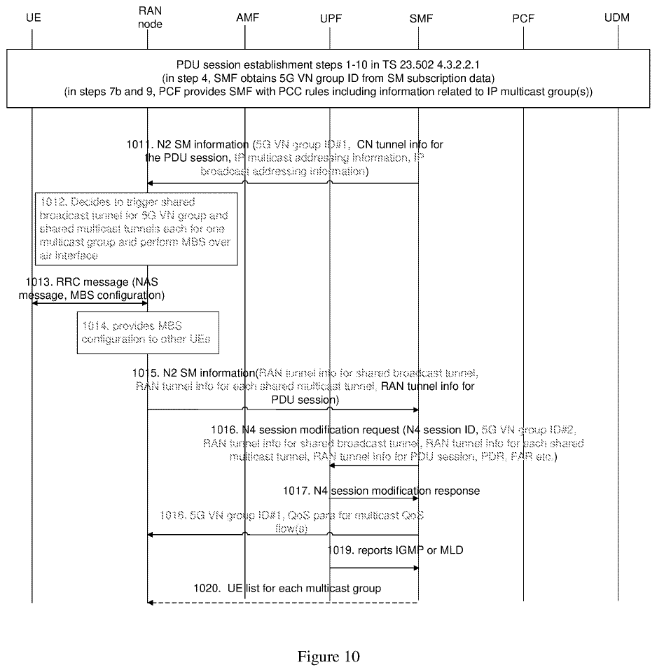

FIG. 10 illustrates the second sub-embodiment of the third embodiment. The steps in FIG. 10 are similar to the steps in FIG. 7. Only steps 1012, 1015 and 1016 are different from steps 712, 715 and 716. Other steps 1011, 1013-1014 and 1017-1020 are the same as steps 711, 713-714 and 717-720.

In step 1012, RAN node determines to trigger, between RAN node and UPF, shared broadcast tunnel for the 5G VN group (identified by 5G VN group ID #1) and shared multicast tunnels each for one multicast group within the 5G VN group. In addition, RAN node determines to perform MBS over air interface for broadcast traffic and multicast traffic within the 5G VN group separately.

In step 715, RAN node provides SMF with the N2 SM information associated with the PDU session including: 5G VN group ID #1, RAN tunnel info for shared tunnel (i.e., for 5G VN group) and RAN tunnel info for PDU session. In step 1015, the RAN tunnel info for shared tunnel is renamed as RAN tunnel info for shared broadcast tunnel, and the N2 SM information further includes RAN tunnel info for each shared multicast tunnel.

Similar to step 1015, in step 1016, the N4 session modification request message includes RAN tunnel info for shared broadcast tunnel (renamed from “RAN tunnel info for shared tunnel”) and further includes RAN tunnel info for each shared multicast tunnel.

According to a third sub-embodiment of the third embodiment, the shared broadcast tunnel for 5G VN group and the shared multicast tunnels for multicast groups are established per node signaling, and are triggered by SMF.

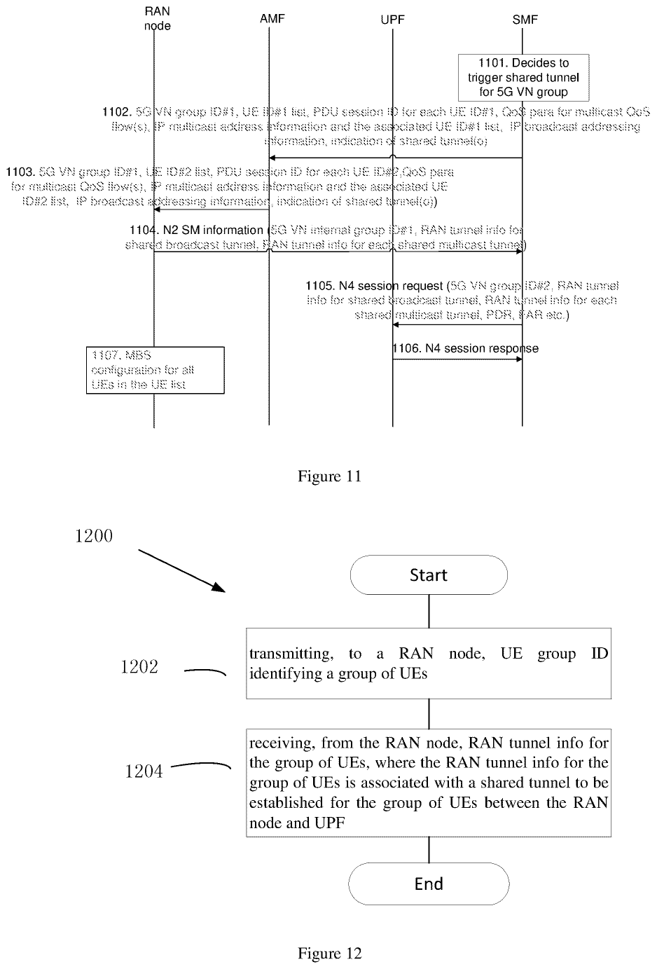

FIG. 11 illustrates the third sub-embodiment of the second embodiment. The steps in FIG. 11 are similar to the steps in FIG. 8. Only steps 1104 and 1105 are different from steps 804 and 805. Other steps 1101-1103 and 1106-1107 are the same as steps 801-803 and 806-807.

In step 804, the N2 SM information includes RAN tunnel info for 5G VN group. In step 1104, the RAN tunnel info for shared tunnel is renamed as RAN tunnel info for shared broadcast tunnel, and the N2 SM information further includes RAN tunnel info for each shared multicast tunnel.

In step 1105, the N4 session request message includes RAN tunnel info for shared broadcast tunnel (renamed from “RAN tunnel info for shared tunnel”) and further includes RAN tunnel info for each shared multicast tunnel.

A fourth embodiment relates to configuration of PDR and FAR for the shared tunnel (e.g., the shared tunnel in the first or the second embodiment, the shared broadcast tunnel and each shared multicast tunnel in the third embodiment).

The forwarding of traffic (e.g., broadcast traffic or multicast traffic) within the 5G VN group is realized by using a UPF internal interface (“5G VN internal”) and a two-step detection and forwarding process. In the first step, the packets received from any 5G VN group member (via PDU Session, via N6 or via N19) are forwarded to the UPF internal interface (i.e., Destination Interface set to “5G VN internal”). The PDR and FAR for the first step are referred to as PDR(in) and FAR(in) in this disclosure.

In the second step, PDRs installed at the UPF internal interface (i.e., Source Interface set to “5G VN internal”) detect the packet and forward it to the respective 5G VN group member (via PDU Session, via N6 or via N19). The PDR and FAR for the second step are referred to as PDR(out) and FAR(out) in this disclosure.

So, the configuration of PDR and FAR for shared tunnel of 5G VN group includes the configuration of PDR(in), FAR(in), PDR(out), and FAR(out) for broadcast configures and/or multicast traffic within 5G VN group.

SMF configures UPF with PDR(in), FAR(in), PDR(out), and FAR(out) for broadcast configures and/or multicast traffic within 5G VN group. It is assumed that SMF knows the broadcast address and/or multicast address(es) in advance. Besides, all the PDRs and FARs not related with the shared tunnel remain the same as defined for 5G VN group. That is, all the broadcast and/or multicast packets of the 5G VN group are forwarded to UPF internal interface marked with “5G VN internal”.

SMF configures the group-level N4 Session for processing broadcast packets and/or multicast packets from source UE, or DN or other UPF and towards other UEs within the same 5G VN group. In order to detect the broadcast traffic and/or multicast traffic, a PDR contains Source Interface set to ‘5G VN internal’, Destination Address set to the broadcast address or multicast address. In order to forward the traffic, a FAR contains Outer Header Creation indicating the shared tunnel information, and Destination Interface set 'access side', where the shared tunnel information is the RAN tunnel info for the shared tunnel (including RAN tunnel info for shared tunnel, RAN tunnel info for the shared broadcast tunnel, or RAN tunnel info for each shared multicast tunnel) associated with the 5G VN group. For example, if PDR includes a destination address for broadcast, the shared tunnel information is for shared broadcast tunnel; if the destination address is for multicast, the shared tunnel information is for shared multicast tunnel; if the destination address is for both broadcast and multicast (e.g., broadcast+multicast), the shared tunnel information is for shared tunnel (for both broadcast and multicast).

If there are more than one 5G VN group in one PLMN, the SMF shall provide the PDRs and FARs related to the UPF internal interface as follows whenever more than one 5G VN group has to be supported in the PLMN:

The FAR with Destination Interface set to ‘5G VN internal’ shall also contain the Network Instance set to the value representing the 5G VN group; and The PDR with Source Interface set to ‘5G VN internal’ shall also contain the Network Instance set to the value representing the 5G VN group.

It means that PDR(out) and FAR(out) shall be modified as follows:

In order to detect the traffic, a PDR contains Source Interface set to ‘5G VN internal’, Network Instance set to a value representing the 5G VN group, Destination Address set to the broadcast address or multicast address. In order to forward the traffic, a FAR contains Outer Header Creation indicating the shared tunnel information, and Destination Interface set ‘access side’, where the shared tunnel information is associated with the 5G VN interface marked with network instance set to a value representing the 5G VN group. For example, if FAR includes a destination address for broadcast, the shared tunnel information is for shared broadcast tunnel; if the destination address for multicast, the shared tunnel information is for shared multicast tunnel; if the destination address is for both broadcast and multicast (e.g., broadcast+multicast), the shared tunnel information is for shared tunnel (for both broadcast and multicast).

A fifth embodiment relates to MRB configuration and user plane handling for multicast group at RAN node.

Take IP multicast group as an example of multicast group. UE may request to join an IP multicast group by sending IGMP or MLD signaling. It is assumed that SMF has the knowledge of the IP multicast group that UE is allowed to join. SMF configures UPF to accept or reject UE request to join the corresponding IP multicast group(s). After UPF triggers IGMP or MLD reporting, SMF knows which UE joins which IP multicast group exactly.

When a shared tunnel is established for both broadcast traffic and multicast traffic, as described in the second embodiment (it means that broadcast traffic and multicast traffic share the same shared tunnel), RAN node is responsible for identifying broadcast traffic and multicast traffic of different IP multicast groups separately. When a shared broadcast tunnel is established for broadcast traffic and shared multicast tunnel(s) each for a specific multicast traffic (associated with a specific multicast group) are established for multicast traffic (as described in the third embodiment), RAN node can identify broadcast traffic and multicast traffic according to which tunnel (a shared broadcast tunnel or a specific shared multicast tunnel) is used.

The broadcast traffic is for all the UEs within the 5G VN group, while the multicast traffic is only for some UEs of the 5G VN group who join the IP multicast group associated with the multicast traffic. The RAN node may decide to trigger MBS for IP multicast group. The UEs in IP multicast group can be enabled to receive the multicast traffic with three options as follows:

In a first option, RAN node provides all UEs in IP multicast group with the new G-RNTI or G-CS-RNTI associated with the IP multicast group, and new MRB ID is associated with IP multicast addressing information (as the TMGI). That is, the broadcast traffic and multicast traffic will be scheduled with different G-RNTIs or G-CS-RNTIs over air interface. UE identifies broadcast traffic and multicast traffic of different IP multicast groups based on different G-RNTIs or G-CS-RNTIs. After RAN node receives the broadcast or multicast packets from UPF, it first checks the destination address. If the destination address is broadcast address, RAN node schedules the broadcast packets with the G-RNTI or G-CS-RNTI associated with 5G VN group ID. If the destination address is multicast address associated with a specific IP multicast group, RAN node schedules the multicast packets with the G-RNTI or G-CS-RNTI associated with the specific IP multicast group.

In a second option, RAN node does not assign new G-RNTI(s) or G-CS-RNTI(s) for the IP multicast group. RAN node sends the broadcast and multicast packets within the same G-RNTI or G-CS-RNTI. After UE receives the broadcast or multicast packets, UE first checks the destination address. If the destination address is broadcast address, UE forwards the broadcast packets to the application associated with PDU session based on MRB ID. If the destination address is multicast address which is associated with an IP multicast group joined by the UE, UE forwards the multicast packets to the application associated with PDU session based on MRB ID. If the destination address is multicast address which is not associated with any IP multicast group joined by the UE, the UE discard the multicast packets.

In a third option, RAN node does not assign new G-RNTI(s) or G-CS-RNTI(s) for the IP multicast group. RAN node first checks the destination address. If the destination address is multicast address, RAN node checks all the UEs that do not belong to the IP multicast group corresponding to the multicast address. RAN node informs the UEs that do not belong to the IP multicast group to skip the corresponding multicast packets. For one example, RAN node sends DCI scrambled with C-RNTI, which includes the skip indication for the packets scrambled with G-RNTI or G-CS-RNTI at the same slot. For another example, the MAC CE or MAC header of each of the multicast or broadcast packets includes the skipped UE's C-RNTI. After UE receives either the DCI scrambled with C-RNTI or the skipped UE's C-RNTI contains in MAC CE or MAC header, UE skips the reception of the multicast packets.

A sixth embodiment relates to the above-mentioned Issue 4.

Steps 313, 314, 413, 414, 507, 613, 614, 713, 714, 807, 913, 914, 1013, 1014, and 1107 are related to MBS configuration.

According to a first embodiment of the sixth embodiment, the current MBS configuration defined in 3GPP Release 17 is modified. It means that the MBS configuration in this disclosure includes, in addition to MRB configuration (e.g., MRB ID, PDCP configuration and the G-RNTI or G-CS-RNTI for 5G VN group etc.), mapping relationship between PDU session ID and MRB ID(s). Upon receiving DCI scrambled by G-RNTI or G-CS-RNTI, UE receives broadcast or multicast packets and identify the MRB. UE identifies the corresponding PDU session based on MRB ID. UE can forward the broadcast or multicast packets to the application associated with the PDU session.

According to a second embodiment of the sixth embodiment, it is assumed that SMF (e.g., in step 311, 411, 502, 611, 711, 802, 911, 1011 or 1102) provides 5G VN group ID in NAS message for UE or in a different NAS signaling from that in step 502, 802 or 1102. RAN node forwards NAS message to UE in step 313, 413, 507, 613, 713, 807, 913, 1013 or 1107. UE binds 5G VN group ID with PDU session ID, and also the application associated with PDU session identified by the PDU session ID. RAN node provides UE with the mapping relationship between 5G VN group ID (as the TMGI) and MRB ID, which is already supported in MRB configuration. Besides, RAN node also provides G-RNTI or G-CS-RNTI for the 5G VN group. That is, MBS configuration over air interface in 3GPP Release 17 can be reused by simply replacing TMGI with 5G VN group ID. In this way, upon receiving DCI scrambled by G-RNTI or G-CS-RNTI, UE receives broadcast or multicast packets and identify the MRB. UE identifies the corresponding 5G VN group ID (as the TMGI) based on MRB ID. UE forwards the broadcast or multicast packets to the corresponding application based on 5G VN group ID or the associated PDU session ID.

As a whole, the first to the third embodiments target Issue 1. In the first embodiment, the shared tunnel for a specific 5G VN group (i.e., broadcast traffic) is established between UPF and RAN node. In the second embodiment, the shared tunnel for both the 5G VN group (i.e., broadcast traffic) and multicast groups (i.e., multicast traffic) is established between UPF and RAN node. In the third embodiment, the shared broadcast tunnel for the 5G VN group (i.e., broadcast traffic) and the shared multicast tunnels each for multicast groups are established between UPF and RAN node.

The fourth embodiment targets Issue 2. SMF configures UPF with PDR(in), FAR(in), PDR(out), and FAR(out) for broadcast traffic and/or multicast traffic within the 5G VN group.

The fifth embodiment targets Issue 3. RAN node is responsible for identifying broadcast traffic and multicast traffic of different IP multicast groups separately. RAN node may provide all UEs in IP multicast group with the new G-RNTI or G-CS-RNTI associated with the IP multicast group. Alternatively, UE checks the destination address after receiving the broadcast or multicast packets. Further alternatively, RAN node informs UEs not belonging to a multicast group to skip the multicast packets associated with the multicast group.

The sixth embodiment targets Issue 4. A mapping relationship between PDU session ID and MRB ID(s) is included in the MBS configuration. UE identifies the corresponding PDU session based on MRB ID. Alternatively, 5G VN group ID is bound with PDU session ID. In addition, TMGI is replaced with 5G VN group ID. UE identifies the 5G VN group ID by MRB ID that is associated with the 5G VN group.

FIG. 12 is a schematic flow chart diagram illustrating an embodiment of a method 1200 according to the present application. In some embodiments, the method 1200 is performed by a network function such as an SMF or a network function with an SMF. In certain embodiments, the method 1200 may be performed by a processor executing program code, for example, a microcontroller, a microprocessor, a CPU, a GPU, an auxiliary processing unit, a FPGA, or the like.

The method 1200 may comprise: 1202 transmitting, to a RAN node, UE group ID identifying a group of UEs; and 1204 receiving, from the RAN node, RAN tunnel info for the group of UEs, where the RAN tunnel info for the group of UEs is associated with a shared tunnel to be established for the group of UEs between the RAN node and UPF.

In some embodiment, the method may further comprise transmitting, to the RAN node, an indication of shared tunnel.

In some embodiment, the method may further comprise transmitting, to the RAN node, CN tunnel info for the PDU session identified by the PDU session ID; and receiving, from the RAN node, RAN tunnel info for the PDU session, where, the RAN tunnel info for the PDU session is associated with a tunnel to be established for the PDU session between the RAN node and the UPF.

In some embodiment, the method may further comprise transmitting, to the RAN node, UE ID and PDU session ID for each UE in the group of UEs.

In some embodiment, the method may further comprise transmitting, to the RAN node, IP multicast addressing information and IP broadcast addressing information.

In some embodiment, the method may further comprise receiving, from the RAN node, RAN tunnel info for each multicast group consisting of a part of the group of UEs, where, the RAN tunnel info for each multicast group is associated with a shared tunnel to be established for the multicast group between the RAN node and the UPF.

In some embodiment, the method may further comprise transmitting, to the UPF, PDR and FAR associated with the group of UEs and/or a part of the group of UEs.

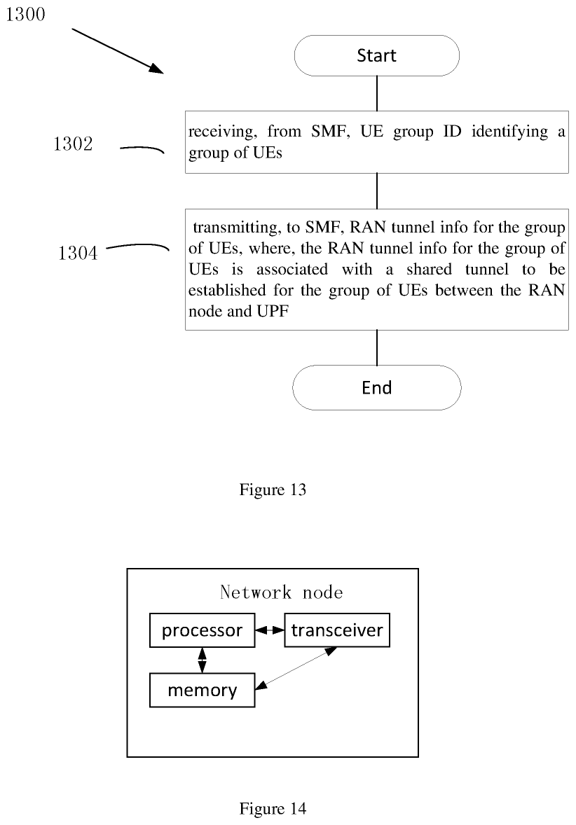

FIG. 13 is a schematic flow chart diagram illustrating an embodiment of a method 1300 according to the present application. In some embodiments, the method 1300 is performed by a network node such as a RAN node (e.g., NG-RAN node). In certain embodiments, the method 1300 may be performed by a processor executing program code, for example, a microcontroller, a microprocessor, a CPU, a GPU, an auxiliary processing unit, a FPGA, or the like.

The method 1300 may comprise 1302 receiving, from SMF, UE group ID identifying a group of UEs; and 1304 transmitting, to SMF, RAN tunnel info for the group of UEs, where, the RAN tunnel info for the group of UEs is associated with a shared tunnel to be established for the group of UEs between the RAN node and UPF.

In some embodiment, the method may further comprise receiving, from the SMF, an indication of shared tunnel.

In some embodiment, the method may further comprise receiving, from the SMF, CN tunnel info for the PDU session identified by the PDU session ID; and transmitting, to the SMF, RAN tunnel info for the PDU session, where, the RAN tunnel info for the PDU session is associated with a tunnel to be established for the PDU session between the RAN node and the UPF.

In some embodiment, the method may further comprise receiving, from the SMF, UE ID and PDU session ID for each UE in the group of UEs.

In some embodiment, the method may further comprise receiving, from the SMF, IP multicast addressing information and IP broadcast addressing information In some embodiment, the method may further comprise transmitting, to the SMF, RAN tunnel info for each multicast group consisting of a part of the group of UEs, where, the RAN tunnel info for each multicast group is associated with a shared tunnel to be established for the multicast group between the RAN node and the UPF.

In some embodiment, the method may further comprise determining to trigger shared tunnel establishment between UPF and RAN node. For example, the shared tunnel can be established for the group of UEs or for both the group of UEs and each multicast group consisting of a part of the group of UEs. For another example, the shared tunnel can be shared broadcast tunnel and/or shared multicast tunnels, while the shared broadcast tunnel can be established for the group of UEs, and each shared multicast tunnel can be established for one multicast group consisting of a specific part of the group of UEs.

In some embodiment, the method may further comprise sending, to all UEs or a part of UEs of the group of UEs, mapping relationship between PDU session ID and MRB ID(s), G-RNTI or G-CS-RNTI associated with the group of UEs.

FIG. 14 is a schematic block diagram illustrating apparatuses according to one embodiment.

The network function or network node or network entity (e.g., SMF or RAN node) includes a processor, a memory, and a transceiver. The processor implements a function, a process, and/or a method which are proposed in FIG. 12 or 13.

SMF comprises a processor and a transceiver coupled to the processor, wherein the processor is configured to transmit, via the transceiver, to a RAN node, UE group ID identifying a group of UEs; and receive, via the transceiver, from the RAN node, RAN tunnel info for the group of UEs, where the RAN tunnel info for the group of UEs is associated with a shared tunnel to be established for the group of UEs between the RAN node and UPF.

In some embodiment, the processor is further configured to transmit, via the transceiver, to the RAN node, an indication of shared tunnel.

In some embodiment, the processor is further configured to transmit, via the transceiver, to the RAN node, CN tunnel info for the PDU session identified by the PDU session ID; and receive, via the transceiver, from the RAN node, RAN tunnel info for the PDU session, where, the RAN tunnel info for the PDU session is associated with a tunnel to be established for the PDU session between the RAN node and the UPF.

In some embodiment, the processor is further configured to transmit, via the transceiver, to the RAN node, UE ID and PDU session ID for each UE in the group of UEs.

In some embodiment, the processor is further configured to transmit, via the transceiver, to the RAN node, IP multicast addressing information and IP broadcast addressing information.

In some embodiment, the processor is further configured to receive, via the transceiver, from the RAN node, RAN tunnel info for each multicast group consisting of a part of the group of UEs, where, the RAN tunnel info for each multicast group is associated with a shared tunnel to be established for the multicast group between the RAN node and the UPF.

In some embodiment, the processor is further configured to transmit, via the transceiver, to UPF, PDR and FAR associated with the group of UEs and/or a part of the group of UEs.

The RAN node comprises a processor and a transceiver coupled to the processor, wherein the processor is configured to receive, via the transceiver, from SMF, UE group ID identifying a group of UEs; and transmit, via the transceiver, to SMF, RAN tunnel info for the group of UEs, where, the RAN tunnel info for the group of UEs is associated with a shared tunnel to be established for the group of UEs between the RAN node and UPF.

In some embodiment, the processor is further configured to receive, via the transceiver, from the SMF, an indication of shared tunnel.

In some embodiment, the processor is further configured to receive, via the transceiver, from the SMF, CN tunnel info for the PDU session identified by the PDU session ID; and transmit, via the transceiver, to the SMF, RAN tunnel info for the PDU session, where, the RAN tunnel info for the PDU session is associated with a tunnel to be established for the PDU session between the RAN node and the UPF.

In some embodiment, the processor is further configured to receive, via the transceiver, from the SMF, UE ID and PDU session ID for each UE in the group of UEs.

In some embodiment, the processor is further configured to receive, via the transceiver, from the SMF, IP multicast addressing information and IP broadcast addressing information.

In some embodiment, the processor is further configured to transmit, via the transceiver, to the SMF, RAN tunnel info for each multicast group consisting of a part of the group of UEs, where, the RAN tunnel info for each multicast group is associated with a shared tunnel to be established for the multicast group between the RAN node and the UPF.

In some embodiment, the processor is further configured to determine to trigger shared tunnel establishment between UPF and RAN node. For example, the shared tunnel can be established for the group of UEs or for both the group of UEs and each multicast group consisting of a part of the group of UEs. For another example, the shared tunnel can be shared broadcast tunnel and/or shared multicast tunnels, while the shared broadcast tunnel can be established for the group of UEs, and each shared multicast tunnel can be established for one multicast group consisting of a specific part of the group of UEs.

In some embodiment, the processor is further configured to send, via the transceiver, to all UEs or a part of UEs of the group of UEs, mapping relationship between PDU session ID and MRB ID(s), G-RNTI or G-CS-RNTI associated with the group of UEs.

Layers of a radio interface protocol may be implemented by the processors. The memories are connected with the processors to store various pieces of information for driving the processors. The transceivers are connected with the processors to transmit and/or receive message or information. Needless to say, the transceiver may be implemented as a transmitter to transmit the information and a receiver to receive the information.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated by the appended claims rather than by the foregoing description. All changes which come within the meaning and range of equivalency of the claims are to be embraced within their scope.

What is claimed is:

1. A session management function (SMF) for wireless communication, comprising:
at least one memory; and
at least one processor coupled with the at least one memory and operable to cause the SMF to:
transmit, to a radio access network (RAN) node, a user equipment (UE) group identifier (ID) identifying a group of UEs; and
receive, from the RAN node, RAN tunnel information for the group of UEs, wherein the RAN tunnel information for the group of UEs is associated with a shared tunnel to be established for the group of UEs between the RAN node and a user plane function (UPF).

2. The SMF of claim 1, wherein, the at least one processor is further operable to cause the SMF to transmit, to the RAN node, an indication of a shared tunnel.

3. The SMF of claim 1, wherein the at least one processor is further operable to cause the SMF to:
transmit, to the RAN node, core network (CN) tunnel information for a protocol data unit (PDU) session identified by a PDU session ID; and
receive, from the RAN node, RAN tunnel information for the PDU session, wherein the RAN tunnel info-information for the PDU session is associated with a tunnel to be established for the PDU session between the RAN node and the UPF.

4. The SMF of claim 1, wherein the at least one processor is further operable to cause the SMF to:
transmit, to the RAN node, a UE ID and a protocol data unit (PDU) session ID for each UE in the group of UEs.

5. The SMF of claim 1, wherein the at least one processor is further operable to cause the SMF to:
transmit, to the RAN node, internet protocol (IP) multicast addressing information and IP broadcast addressing information.

6. The SMF of claim 1, wherein the at least one processor is further operable to cause the SMF to:
receive, from the RAN node, RAN tunnel information for one or more multicast groups, wherein each multicast group comprises of a part of the group of UEs, where, and wherein the RAN tunnel information for each multicast group is associated with a shared tunnel to be established for the multicast group between the RAN node and the UPF.

7. The SMF of claim 1, wherein the at least one processor is further operable to cause the SMF to:
transmit, to the UPF, a packet detection rule (PDR) and a forwarding action rule (FAR) associated with one or more of the group of UEs or a part of the group of UEs.

8. A method performed at a session management function (SMF), comprising:
transmitting, to a radio access network (RAN) node, a user equipment (UE) group identifier (ID) identifying a group of UEs; and
receiving, from the RAN node, RAN tunnel information for the group of UEs, wherein the RAN tunnel information for the group of UEs is associated with a shared tunnel to be established for the group of UEs between the RAN node and a user plane function (UPF).

9. A radio access network (RAN) node for wireless communication, comprising:
at least one memory; and
at least one processor coupled with the at least one memory and operable to cause the RAN node to:
receive, from a session management function (SMF), a user equipment (UE) group identifier (ID) identifying a group of UEs; and
transmit, to the SMF, RAN tunnel information for the group of UEs, wherein the RAN tunnel information for the group of UEs is associated with a shared tunnel to be established for the group of UEs between the RAN node and a user plane function (UPF).

10. The RAN node of claim 9, wherein the at least one processor is further operable to cause the RAN node to:
receive, from the SMF, an indication of a shared tunnel.

11. The RAN node of claim 9, wherein the at least one processor is further operable to cause the RAN node to:
receive, from the SMF, core network (CN) tunnel information for a protocol data unit (PDU) session identified by a PDU session ID; and
transmit, to the SMF, RAN tunnel information for the PDU session, wherein the RAN tunnel information for the PDU session is associated with a tunnel to be established for the PDU session 17 between the RAN node and the UPF.

12. The RAN node of claim 9, wherein the at least one processor is further operable to cause the RAN node to:
receive, from the SMF, internet protocol (IP) multicast addressing information and IP broadcast addressing information.

13. The RAN node of claim 9, wherein the at least one processor is further operable to cause the RAN node to:
transmit, to the SMF, RAN tunnel information for one or more multicast groups, wherein each multicast group comprises a part of the group of UEs.

14. The RAN node of claim 9, wherein the at least one processor is further operable to cause the RAN node to:
determine to trigger a shared tunnel establishment between the UPF and the RAN node.

15. The RAN node of claim 9, wherein the at least one processor is further operable to cause the RAN node to:
send, to the group of UEs or a part of the group of UEs, a mapping relationship between a protocol data unit (PDU) session ID and one or more multicast and broadcast service radio bearer (MRB) IDs, group radio network temporary identifier (G-RNTI), or group configured scheduling radio network temporary identifier (G-CS-RNTI) associated with the group of UEs.

16. A method performed at a radio access network (RAN) node, comprising:
receiving, from a session management function (SMF), a user equipment (UE) group identifier (ID) identifying a group of UEs; and
transmitting, to the SMF, RAN tunnel information for the group of UEs, wherein the RAN tunnel information for the group of UEs is associated with a shared tunnel to be established for the group of UEs between the RAN node and a user plane function (UPF).

17. The method of claim 8, further comprising transmitting, to the RAN node, an indication of a shared tunnel.

18. The method of claim 8, further comprising:
transmitting, to the RAN node, core network (CN) tunnel information for a protocol data unit (PDU) session identified by a PDU session ID; and
receiving, from the RAN node, RAN tunnel information for the PDU session, wherein the RAN tunnel information for the PDU session is associated with a tunnel to be established for the PDU session between the RAN node and the UPF.

19. The method of claim 8, further comprising:
transmitting, to the RAN node, a UE ID and a protocol data unit (PDU) session ID for each UE in the group of UEs.

20. The method of claim 8, further comprising:
transmitting, to the RAN node, internet protocol (IP) multicast addressing information and IP broadcast addressing information.
